(19) United States
(12) Patent Application Publication
(10) Pub. No.: US 2025/0071741 A1
(43) Pub. Date: Feb. 27, 2025

(54) COMMUNICATION METHOD AND COMMUNICATION APPARATUS

(71) Applicant: GUANGDONG OPPO MOBILE TELECOMMUNICATIONS CORP., LTD., Dongguan (CN)

(72) Inventors: Shichang ZHANG, Dongguan (CN); Teng MA, Dongguan (CN); Zhenshan ZHAO, Dongguan (CN)

(21) Appl. No.: 18/949,421

(22) Filed: Nov. 15, 2024

Related U.S. Application Data
(63) Continuation of application No. PCT/CN2022/111786, filed on Aug. 11, 2022.

(51) Int. Cl. H04W 72/0446; H04L 5/00; H04W 72/0457; H04W 72/25; H04W 72/40

(52) U.S. Cl. CPC H04W 72/0446; H04W 72/0457; H04W 72/25; H04W 72/40; H04L 5/0007

(57) ABSTRACT

A communication method includes: transmitting, by a first terminal device, first information to a second terminal device, where the first information is used to indicate a first reference value in a first time slot, and the first reference value is used by the first terminal device to calculate a reference number of OFDM symbols when determining TBS.

### CROSS-REFERENCE TO RELATED APPLICATION

This application is a Continuation Application of International Application No. PCT/CN2022/111786 filed on Aug. 11, 2022, which is incorporated herein by reference in its entirety.

### TECHNICAL FIELD

The present disclosure relates to the field of communication technologies, and in particular, to a communication method and a communication apparatus.

### BACKGROUND

With the development of communication technologies, some communication systems support a transmission by utilizing an unlicensed frequency band, to improve a spectrum utilization rate of the system. However, there are still some problems when a sidelink (SL) transmission is performed on the unlicensed frequency band.

### SUMMARY

The present disclosure provides a communication method and a communication apparatus. The various aspects involved in embodiments of the present disclosure are introduced below.

In a first aspect, a communication method is provided, and the method includes: transmitting, by a first terminal device, first information to a second terminal device, where the first information is used to indicate a first reference value in a first time slot, and the first reference value is used by the first terminal device to calculate a reference number of orthogonal frequency division multiplexing (OFDM) symbols when determining transmission block size (TBS).

In a second aspect, a communication method is provided, and the method includes: receiving, by a second terminal device, first information transmitted by a first terminal device, where the first information is used to indicate a first reference value in a first time slot, and the first reference value is used by the first terminal device to calculate a reference number of orthogonal frequency division multiplexing (OFDM) symbols when determining transmission block size (TBS).

In a third aspect, a communication apparatus is provided, and the apparatus includes: a transmitting unit, configured to transmit first information to a second terminal device, where the first information is used to indicate a first reference value in a first time slot, and the first reference value is used by the apparatus to calculate a reference number of orthogonal frequency division multiplexing (OFDM) symbols when determining transmission block size (TBS).

In a fourth aspect, a communication apparatus is provided, and the apparatus includes: a receiving unit, configured to receive first information transmitted by a first terminal device, where the first information is used to indicate a first reference value in a first time slot, and the first reference value is used by the first terminal device to calculate a reference number of orthogonal frequency division multiplexing (OFDM) symbols when determining transmission block size (TBS).

In a fifth aspect, a communication apparatus is provided, and includes a memory, a transceiver and a processor, where the memory is configured to store a program, the transceiver is configured to transmit and receive data, and the processor is configured to call the program in the memory, to perform the method described in the first aspect or the second aspect.

In a sixth aspect, a communication apparatus is provided, and includes a processor, configured to call a program from a memory, to perform the method described in the first aspect or the second aspect.

In a seventh aspect, a chip is provided, and includes a processor, configured to call a program from a memory, to cause a device equipped with the chip to perform the method described in the first aspect or the second aspect.

In an eighth aspect, a non-transitory computer-readable storage medium is provided, and a program is stored on the non-transitory computer-readable storage medium, where the program causes a computer to perform the method described in the first aspect or the second aspect.

In a ninth aspect, a computer program product is provided, and includes a program, where the program causes a computer to perform the method described in the first aspect or the second aspect.

In a tenth aspect, a computer program is provided, where the computer program causes a computer to perform the method described in the first aspect or the second aspect.

### BRIEF DESCRIPTION OF THE DRAWINGS

FIG. 1 is an exemplary diagram of a wireless communication system applied by an embodiment of the present disclosure.

FIG. 2 is an exemplary diagram of a wireless communication system applied by another embodiment of the present disclosure.

FIG. 3 is an exemplary diagram of a wireless communication system applied by yet another embodiment of the present disclosure.

FIG. 4 is an exemplary diagram of a wireless communication system applied by yet another embodiment of the present disclosure.

FIG. 5 is an exemplary diagram of a unicast transmission in the embodiments of the present disclosure.

FIG. 6 is an exemplary diagram of a multicast transmission in the embodiments of the present disclosure.

FIG. 7 is an exemplary diagram of a broadcast transmission in the embodiments of the present disclosure.

FIG. 8A is an exemplary diagram of a time slot structure in V2X in the embodiments of the present disclosure.

FIG. 8B is another exemplary diagram of a time slot structure in V2X in the embodiments of the present disclosure.

FIG. 9 is a schematic diagram of PSFCH resources and a number of corresponding OFDM symbols in a time slot.

FIG. 10 is a schematic diagram of a mapping method of second-order SCI.

FIG. 11 is a schematic diagram of DMRS time-frequency domain positions in a PSCCH.

FIG. 12 is a schematic diagram of time domain positions of 4 DMRS symbols when a PSSCH has a number of symbols of 13.

FIG. 13 is a schematic diagram of single-symbol DMRS frequency domain type 1.

FIG. 14 is a schematic diagram of a time-frequency position of a SL CSI-RS.

FIG. 15 is a schematic diagram of channel occupy time and channel occupy.

FIG. 16 is a schematic diagram of performing LBT on an unlicensed spectrum.

FIG. 17 is a schematic flowchart of a communication method provided by an embodiment of the present disclosure.

FIG. 18 is a schematic diagram of a starting point position and a number of OFDM symbols in an embodiment of the present disclosure.

FIG. 19 is a schematic diagram of a starting point position and a number of OFDM symbols in another embodiment of the present disclosure.

FIG. 20 is a schematic diagram of a starting point position and a number of OFDM symbols in yet another embodiment of the present disclosure.

FIG. 21 is a schematic structural diagram of a communication apparatus provided by an embodiment of the present disclosure.

FIG. 22 is a schematic structural diagram of a communication apparatus provided by another embodiment of the present disclosure.

FIG. 23 is a schematic structural diagram of an apparatus provided by an embodiment of the present disclosure.

### DETAILED DESCRIPTION

Technical solutions in the present disclosure will be described below with reference to the drawings.

The technical solutions in the embodiments of the present disclosure may be applied to various communication systems, such as: a 5th generation (5G) system, or a new radio (NR), long term evolution (LTE) system, an LTE frequency division duplex (FDD) system, an LTE time division duplex (TDD) system, or the like. The technical solutions provided by the present disclosure may also be applied to future communication systems, such as a 6th generation mobile communication system, a satellite communication system, or the like.

A user equipment (UE) in the embodiments of the present disclosure may also be referred to as a terminal device, an access terminal, a user unit, a user station, a mobile platform, a mobile station (MS), a mobile terminal (MT), a remote station, a remote terminal, a mobile device, a user terminal, a terminal, a wireless communication device, a user agent or a user apparatus. The UE in the embodiments of the present disclosure may refer to a device that provides voice and/or data connectivity to a user and may be used to connect people, objects, and machines, such as a handheld device or vehicle-mounted device with a wireless connection function, etc. The UE in the embodiments of the present disclosure may be a mobile phone, a pad, a laptop computer, a handheld computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, etc. Optionally, the UE may be used to act as a base station. For example, the UE may act as a scheduling entity, that provides sidelink signals between UEs in vehicle to everything (V2X) or device to device (D2D), or the like. For example, a cellular phone and a car communicate with each other by using the sidelink signals. The cellular phone and a smart home device communicate with each other without relaying the communication signal via a base station.

The network device in the embodiments of the present disclosure may be a device for communicating with the UE, and the network device may also be referred to as an access network device or a wireless access network device, e.g., the network device may be a base station. The network device in the embodiments of the present disclosure may refer to a radio access network (RAN) node (or device) that accesses the UE to a wireless network. The base station may broadly cover the following various names, or be replaced with the following names, such as: node B (NodeB), evolved base station (evolved NodeB, eNB), next generation base station (next generation NodeB, gNB), relay station, access point, transmission point (transmitting and receiving point, TRP), transmitting point (TP), master station MeNB, secondary station SeNB, multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node, or the like. The base station may be a macro base station, a micro base station, a relay node, a donor node, or the like, or a combination thereof.

It should be understood that all or a part of functions of the network device and the UE in the present disclosure may also be implemented by a software function running on hardware, or implemented by a virtualized function instantiated on a platform (e.g., a cloud platform).

It should be understood that the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

The terms used in the implementation parts of the present disclosure are only used to explain the embodiments of the present disclosure, but not intended to limit the present disclosure. The terms “first”, “second”, “third” and “fourth”, etc., in the specification, claims, and drawings of the present disclosure are used to distinguish different objects, rather than to describe a specific order. In addition, the terms “include” and “have” and any variations thereof, are intended to cover non-exclusive inclusion.

It should be understood that the “indication” mentioned in the embodiments of the present disclosure may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present disclosure, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In the present disclosure, the “predefined” may be implemented by pre-saving corresponding codes, tables or other manners that may be used to indicate related information, in the device (for example, including the terminal device and the network device), and the present disclosure does not limit its implementation. For example, the predefined may refer to what is defined in a protocol.

In the present disclosure, the “protocol” may refer to standard protocols in the communication field, for example, may include an LTE protocol, an NR protocol, and related protocols applied in future communication systems, which are not limited to the present disclosure.

The technical solutions in the embodiments of the present disclosure may be applied to sidelink communication. The sidelink communication is introduced first in detail below.

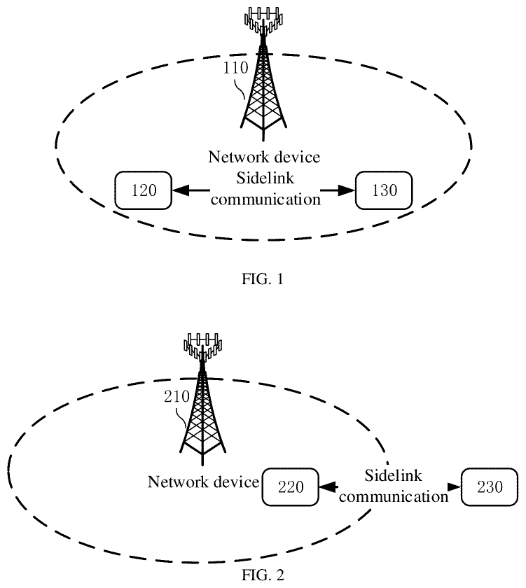

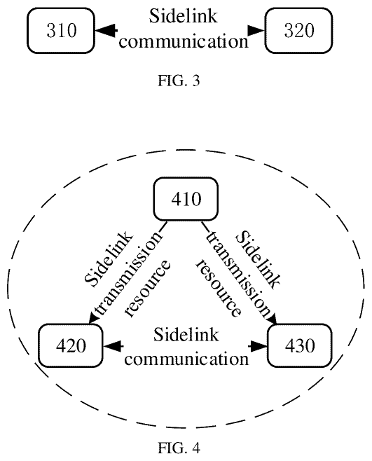

In the sidelink communication, according to different network coverage situations of the terminal device for communicating, the sidelink communication may be divided into sidelink communication within network coverage, sidelink communication with partial network coverage, and sidelink communication outside network coverage, as shown in FIG. 1, FIG. 2, FIG. 3 and FIG. 4, respectively.

In the sidelink communication within network coverage, all the terminal devices performing the sidelink communication are within a coverage range of a same base station. As shown in FIG. 1, both terminal devices 120 and 130 are within the network coverage of a network device 110, and may receive a sidelink configuration transmitted by the network device 110, and perform sidelink communication based on the sidelink configuration.

In a case of the sidelink communication with partial network coverage, a part of terminal devices performing sidelink communication are located within the coverage range of the network device. As shown in FIG. 2, a terminal device 220 can receive the sidelink configuration of a network device 210 and perform sidelink communication based on the sidelink configuration, while a terminal device 230 located outside the network coverage range cannot receive the sidelink configuration of the network device 210. In this case, the terminal device 230 outside the network coverage range may determine the sidelink configuration according to pre-configuration information and information carried in a physical sidelink broadcast channel (PSBCH) transmitted by the terminal device 220, and perform sidelink communication based on the sidelink configuration.

For the sidelink communication outside network coverage, all terminal devices performing sidelink communication are located outside the network coverage range. As shown in FIG. 3, terminal devices 310 and 320 are both located outside the network coverage range. At this time, the terminal devices 310 and 320 may determine the sidelink configuration according to the pre-configuration information, respectively, and perform sidelink communication based on the sidelink configuration.

In sidelink communication, a plurality of terminal devices may also form a communication group, the communication group has a central control node, and the central control node may also become a cluster header (CH) terminal. The central control node has one of the following functions: responsible for the establishment of the communication group; controlling the joining and leaving of group members; coordinating resources, i.e., allocating sidelink transmission resources to other terminal devices in the communication group, and receiving sidelink feedback information of other terminal devices; coordinating resources with other communication groups, etc. As shown in FIG. 4, terminal devices 410, 420 and 430 form a communication group, the terminal device 410 is the central control node of the communication group, the terminal devices 420 and 430 are group members, and the terminal device 410 can allocate sidelink transmission resources to the terminal devices 420 and 430.

Device-to-device communication is a sidelink (SL) transmission technology based on D2D. Different from that communication data is received or transmitted via the network device in the traditional cellular system, the device-to-device communication has higher spectrum efficiency and lower transmission latency. For example, the Internet of Vehicles system may communicate by using terminal-to-terminal communication. Currently, in the 3rd generation partnership project (3GPP), two transmission modes for the device-to-device communication are defined: a first mode and a second mode.

The first mode: transmission resources of the terminal device are allocated by the network device, and the terminal device transmits data on the sidelink according to the resources allocated by the network device; the network device may allocate a resource for a single transmission to the terminal device, and may also allocate a resource for a semi-static transmission to the terminal device. For example, as shown in FIG. 1, the terminal device is located within the network coverage range, and the network device allocates a transmission resource for a sidelink transmission to the terminal device.

The second mode: the terminal device selects a resource in a resource pool to transmit data. For example, as shown in FIG. 3, the terminal device is located outside the network coverage range. At this time, the terminal device may autonomously select a transmission resource from a pre-configured resource pool to preform the sidelink transmission; or, as shown in FIG. 1, the terminal device may also autonomously select a transmission resource from a resource pool configured by the network to perform the sidelink transmission.

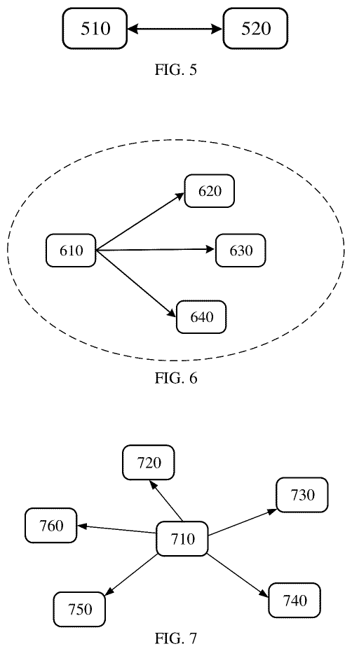

New radio vehicle to everything (NR-V2X) is a sidelink transmission technology applied for vehicular wireless communication. In NR-V2X, unicast, multicast and broadcast transmission modes are supported. For the unicast transmission, there is only one terminal in its receiving end terminal, as shown in FIG. 5, the unicast transmission is performed between a terminal device 510 and a terminal device 520; for the multicast transmission, its receiving end is all terminal devices in one communication group, or all terminal devices within a certain transmission distance, as shown in FIG. 6, terminal devices 610, 620, 630 and 640 constitute a communication group, where the terminal device 610 transmits data, and other terminal devices in the communication group are all receiving end terminal devices; for the broadcast transmission, its receiving end is any terminal around the transmitting end terminal device, as shown in FIG. 7, a terminal device 710 is the transmitting end terminal device, terminal devices 720 to 760 are all receiving end terminal devices around the terminal device 710, and the terminal device 710 may transmit data to the terminal devices 720 to 760.

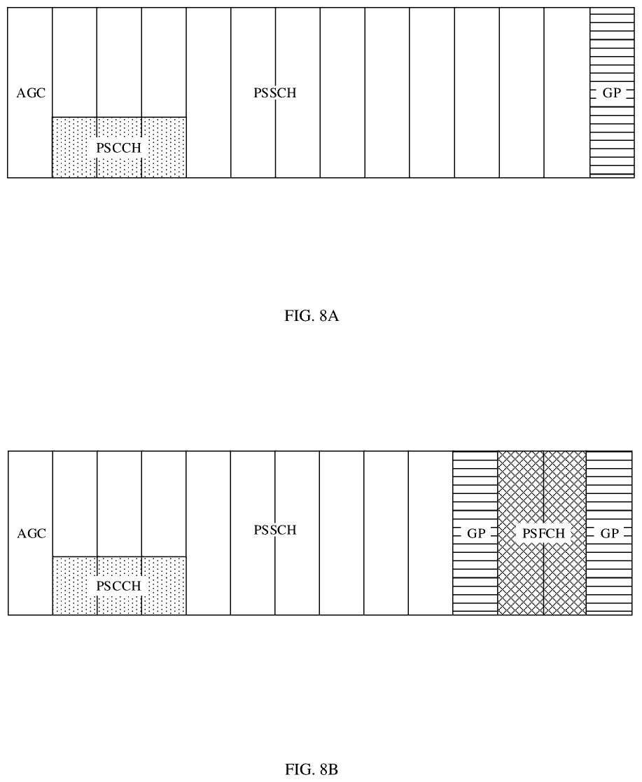

A time slot structure in NR-V2X may be shown in FIG. 8A represents a time slot structure in which a physical sidelink feedback channel (PSFCH) is not included in the time slot; and in FIG. 8B represents a time slot structure in which the PSFCH is included.

As shown in FIG. 8A and FIG. 8B, a physical sidelink control channel (PSCCH) in NR-V2X occupies 2 or 3 orthogonal frequency division multiplexing (OFDM) symbols starting from a second sidelink symbol of the time slot in time domain, and may occupy {10, 12 15, 20, 25} physical resource blocks (PRBs) in frequency domain. In order to reduce the complexity of blind detection of the PSCCH by UE, only one number of PSCCH symbol and one number of PRB may be configured in one resource pool. In addition, because a subchannel is a minimum granularity for physical sidelink shared channel (PSSCH) resource allocation in NR-V2X, the number of PRBs occupied by the PSCCH may be less than or equal to the number of PRBs contained in one subchannel within the resource pool, so as to avoid additional restrictions on PSSCH resource selection or allocation. The PSSCH also starts from the second sidelink symbol of the time slot in time domain. A last time domain symbol in the time slot is a guard period (GP) symbol, and the remaining symbols are mapped to the PSSCH. A first sidelink symbol in the time slot is a repetition of the second sidelink symbol. Usually, the receiving end terminal device uses the first sidelink symbol as an automatic gain control (AGC) symbol, and data on this symbol is usually not used for data demodulation. The PSSCH may occupy K subchannels in frequency domain, each subchannel may include M consecutive PRBs, and K and M are integers.

As shown in FIG. 8B, when the time slot contains the PSFCH channel, a second-to-last symbol and a third-to-last symbol in the time slot are used for the PSFCH channel transmission, and a time domain symbol before the PSFCH channel is used as a GP symbol.

In NR-V2X, the PSSCH is used to carry second-order sidelink control information (SCI) (such as SCI 2-A or SCI 2-B, see subsequent descriptions for details) and data information. The second-order SCI adopts Polar coding and fixedly adopts quadrature phase shift keying (QPSK) modulation. A data part of the PSSCH adopts low density parity check (LDPC) code, and the highest modulation order supported is 256 quadrature amplitude modulation (QAM).

In NR-V2X, the PSSCH supports up to two stream transmissions, and adopts a unit precoding matrix to map data on two layers to two antenna ports. At most one transport block (TB) can be transmitted in one PSSCH. However, different from the transmission method of the data part of the PSSCH, when the PSSCH adopts a dual-stream transmission method, the modulation symbols transmitted by the second-order SCI on the two streams are exactly the same. Such a design may ensure the reception performance of the second-order SCI under the highly correlated channel.

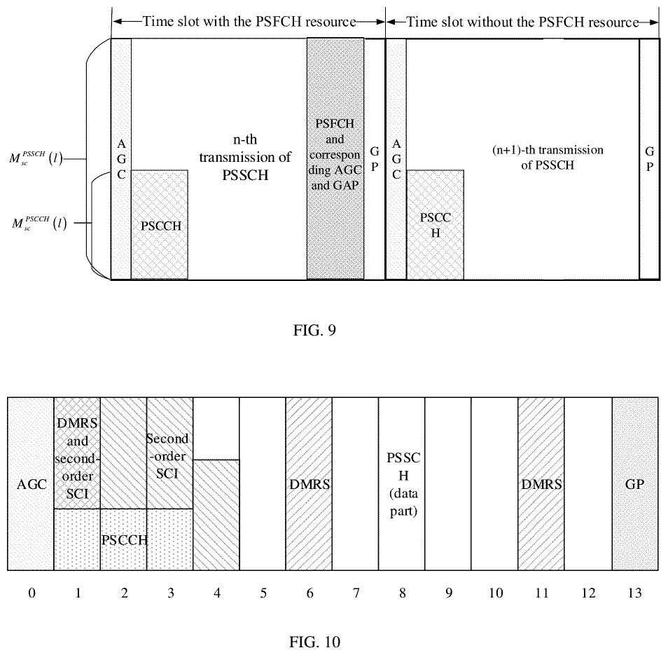

Since the maximum number of retransmissions of one PSSCH is 32 in NR-V2X, if there is a PSFCH resource in the resource pool and a configuration period of the PSFCH resource is 2 or 4, available OFDM symbols in the time slots in which different transmissions of one PSSCH are located, may change, as shown in FIG. 9. If N_{symbol}^{PSSCH} is calculated according to the actual number of OFDM symbols in a time slot (N_{symbol}^{PSSCH} represents a reference value of the number of symbols occupied by the PSSCH), Q_{SC12}′ may be different due to the different number of symbols available for the PSSCH transmissions in a time slot, and the change of Q_{SC12}′ will lead to the change of the size of the TB carried by the PSSCH, as described below. In order to ensure that the transmission block size (TBS) remains unchanged in multiple transmissions of the PSSCH, the actual number of PSFCH symbols is not adopted when calculating N_{symbol}^{PSSCH}. In addition, when calculating M_{sc}^{SC12}, the number of resource elements (REs) occupied by the PSSCH demodulation reference signal (DMRS) and the number of REs occupied by the phase tracking reference signal (PT-RS), which may change in the retransmission process, are also not taken into account. Herein, n and/in FIG. 9 are integers.

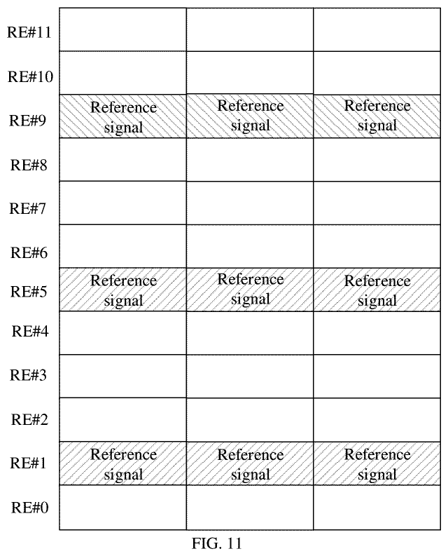

A code rate of the second-order SCI may be dynamically adjusted within a certain range. The code rate used is indicated by the first-order SCI, so the receiving end does not need to perform blind detection on the second-order SCI even after the code rate changes. The modulation symbols of the second-order SCI are mapped starting from a symbol in which a first PSSCH DMRS is located in, using the frequency domain first and then the time domain. On the OFDM symbol in which the DMRS is located, the second-order SCI is mapped to the RE not occupied by the DMRS, as shown in FIG. 10.

The data part of the PSSCH in a resource pool may use a plurality of different modulation and coding scheme (MCS) tables, including the conventional 64QAM MCS table, 256QAM MCS table, and low spectrum efficiency 64QAM MCS table. The MCS table used in one transmission is indicated by an “MCS table indication” field in the first-order SCI. In order to control the peak to average power ratio (PAPR), the PSSCH must be transmitted by using consecutive PRBs. Since the subchannel is the minimum frequency domain resource granularity of the PSSCH, this requires that the PSSCH must occupy consecutive subchannels.

The PSSCH follows the determination mechanism of transmission block size (TBS) of the PDSCH (Physical Downlink Shared Channel) and PUSCH (Physical Uplink Shared Channel) in NR, that is, the TBS is determined according to a reference value of the number of REs used for the PSSCH in a time slot in which the PSSCH is located, so that the actual code rate is as close to the target code rate as possible. The purpose of using the reference value of the number of REs instead of the actual number of REs here is to ensure that the number of REs used to determine the TBS remains unchanged in the PSSCH retransmission process, so that the determined TBS size remains the same. To achieve this purpose, the reference value of the number of REs occupied by the PSSCH in the TBS determination process is determined according to the following formula (1):

$${N}_{RE} = {N}_{RE}^{′} \cdot {n}_{PRB} - {N}_{RE}^{SCI , 1} - {N}_{RE}^{SCI , 2} \qquad ( 1 )$$

where n_{PRB} is the number of PRBs occupied by the PSSCH, N_{RE}^{SCI,1} is the number of REs occupied by the first-order SCI (including REs occupied by the DMRS of the PSCCH), N_{RE}^{SCI,2} is the number of REs occupied by the second-order SCI, and N_{RE}′ represents the reference number of REs available for the PSSCH in one PRB. N_{RE}′ may be determined by the following formula (2):

$${N}_{RE}^{′} = {N}_{sc}^{RB} ( {N}_{symb}^{sh} - {N}_{symb}^{PSFCH} ) - {N}_{oh}^{PRB} - {N}_{RE}^{DMRS} \qquad ( 2 )$$

where N_{sc}^{RB}=12 represents the number of subcarriers in a PRB; N_{symb}^{sh} represents the number of symbols available for sidelink in a time slot, excluding a last GP symbol and a first symbol for AGC; N_{symb}^{PSFCH}=0 or 3, the value is indicated by a “PSFCH symbol number” field in the first-order SCI, and is a reference value of the number of symbols occupied by the PSFCH; a value of Nₒₕ^{PRB} is configured by an RRC (Radio Resource Control) layer parameter, and used to indicate a reference value of the number of REs occupied by the PT-RS and channel state information reference signal (CSI-RS); N_{RE}^{DMRS} represents an average number of DMRS REs in a time slot, and is related to a DMRS pattern allowed in the resource pool, and their correspondence may be shown in the following Table 1.

TABLE 1
Correspondence between a DMRS pattern allowed in the
resource pool and N_{RE}^{DMRS}

| DMRS pattern | N_{RE}^{DMRS} |
|---|---|
| {2} | 12 |
| {3} | 18 |
| {4} | 24 |
| {2, 3} | 15 |
| {2, 4} | 18 |
| {3, 4} | 21 |
| {2, 3, 4} | 18 |

In NR-V2X, the DMRS pattern of the PSCCH is the same as that of the NR physical downlink control channel (PDCCH), that is, the DMRS exists on each OFDM symbol of the PSCCH, and is located in {#1, #5, #9} REs of a PRB in the frequency domain, as shown in FIG. 11. The DMRS sequence of the PSCCH is generated by the following formula (3):

$${r}_{l} ( m ) = \frac{1}{\sqrt{2}} ( 1 - 2 c ( m ) ) + j \frac{1}{\sqrt{2}} ( 1 - 2 c ( m + 1 ) ) \qquad ( 3 )$$

where the pseudo random sequence c(m) is initialized by cᵢₙᵢₜ=(2¹⁷(N_{symb}^{slot}n_{s,f}^{μ}+l+1+)(2N_{ID}+1)+2N_{ID}) mod 2³¹, here, l is an index of the OFDM symbol in which the DMRS is located in a time slot, n_{s,f}^{u}, is an index of the time slot in which the DMRS is located in a system frame, N_{symb}^{slot} slot represents the number of OFDM symbols in a time slot, N_{ID}∈{0,1, . . . , 65535} and the value of N_{ID} in a resource pool is configured or pre-configured by the network.

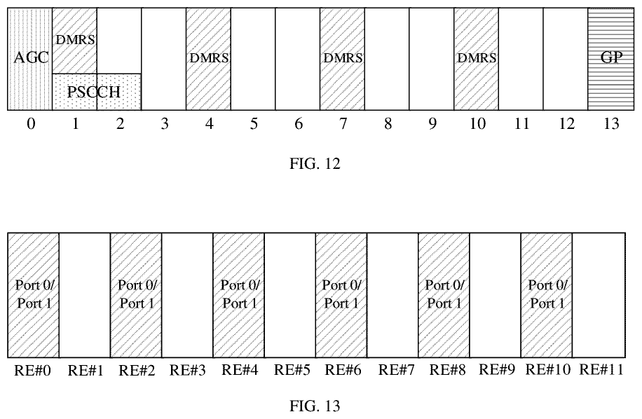

NR-V2X borrows the design in the NR Uu interface, and uses multiple time-domain PSSCH DMRS patterns. In a resource pool, the number of available DMRS patterns is related to the number of PSSCH symbols in the resource pool. For a specific number of PSSCH symbols (including a first AGC symbol) and a specific number of PSCCH symbols, the available DMRS patterns and the position of each DMRS symbol in the pattern are shown in Table 2 below. FIG. 12 shows a schematic diagram of time domain positions of 4 DMRS symbols when the PSSCH has a number of symbols of 13.

TABLE 2
Number and positions of DMRS symbols under different
number of PSSCH symbols and PSCCH symbols

| Number of | | | | | | |
|---|---|---|---|---|---|---|
| PSSCH | | | | | | |
| symbols | DMRS symbol position (relative to the first AGC symbol position) | | | | | |
| (including the | The number of PSCCH symbols is 2 | | | The number of PSCCH symbols is 3 | | |
| first AGC | The number of DMRS symbols | | | The number of DMRS symbols | | |
| symbol) | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

If a plurality of time-domain DMRS patterns are configured in a resource pool, the time-domain DMRS pattern used is selected by the transmitting UE and indicated in the first-order SCI. Such a design allows the UE moving at high speed to select a DMRS pattern with high density, thereby ensuring the accuracy of channel estimation, while for the UE moving at low speed, a DMRS pattern with low density may be used, thereby improving spectrum efficiency.

The generation method of the PSSCH DMRS sequence is almost exactly the same as the generation method of the PSCCH DMRS sequence. The only difference is that, in the initialization formula cᵢₙᵢₜ of the pseudo random sequence c(m), N_{ID}=Σᵢ₌₀^{L-1}Pᵢ·2^{L-1-1}, pᵢ is the i-th CRC of the PSCCH that schedules the PSSCH, and L=24 is the number of bits of the PSCCH CRC (Cyclic Redundancy Check).

Two frequency-domain DMRS patterns are supported in the NR PDSCH and PUSCH, i.e., DMRS frequency domain type 1 and DMRS frequency domain type 2, and for each frequency domain type, there are two different types: single DMRS symbol and dual DMRS symbol. The single symbol DMRS frequency domain type 1 supports 4 DMRS ports, and the single symbol DMRS frequency domain type 2 may support 6 DMRS ports. In the case of the dual DMRS symbol, the supported number of ports is doubled. However, in NR-V2X, since the PSSCH only needs to support two DMRS ports at most, only the single symbol DMRS frequency domain type 1 is supported, as shown in FIG. 13.

To support the unicast communication, the SL CSI-RS is supported in NR-V2X. The SL CSI-RS is transmitted only when the following three conditions are met:
(1) UE transmits the corresponding PSSCH, that is, the UE cannot only transmit the SL CSI-RS;
(2) a high layer signaling activates sidelink CSI reporting;
(3) in a case where the high layer signaling activates the sidelink CSI reporting, a corresponding bit in the second-order SCI transmitted by the UE triggers the sidelink CSI reporting.

The maximum number of ports supported by the SL CSI-RS is 2. When there are two ports, the SL CSI-RS of different ports is multiplexed by code division on two adjacent REs of the same OFDM symbol. The number of SL CSI-RS of each port in a PRB is 1, that is, the density is 1. Therefore, in a PRB, the SL CSI-RS will appear on at most one OFDM symbol. The position of this OFDM symbol is determined by the transmitting terminal. In order to avoid affecting the resource mapping of the PSCCH and the second-order SCI, the SL CSI-RS cannot be located in the same OFDM symbol as the PSCCH and the second-order SCI. Since the channel estimation accuracy of the OFDM symbol in which the PSSCH DMRS is located, is higher, and the SL CSI-RS of the two ports will occupy two consecutive REs in the frequency domain, the SL-CSI-RS also cannot be transmitted on the same OFDM symbol as the PSSCH DMRS. The position of the OFDM symbol in which the SL CSI-RS is located, is indicated by a sl-CSI-RS-FirstSymbol parameter in PC5 RRC.

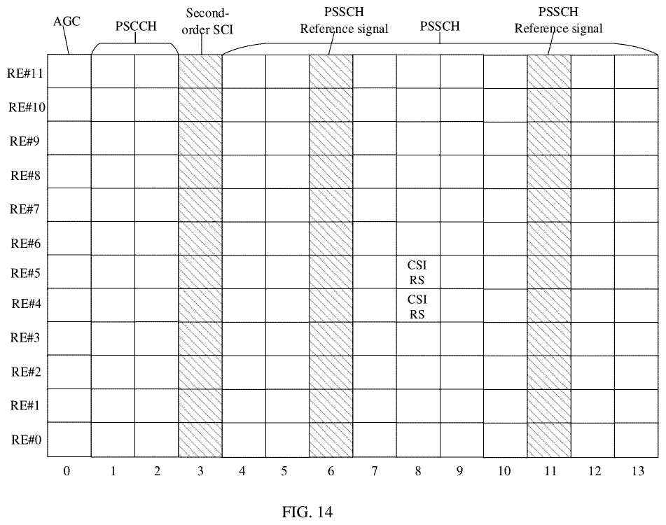

A position of a first RE occupied by the SL CSI-RS in a PRB is indicated by a sl-CSI-RS-FreqAllocation parameter in PC5 RRC. If the SL CSI-RS is one port, this parameter is a bit map with a length of 12, corresponding to 12 REs in one PRB. If the SL CSI-RS is two ports, this parameter is a bit map with a length of 6. In this case, the SL CSI-RS occupies two RES 2f(1) and 2f(1)+1 where f(1) represents the index of the bit with a value of 1 in the above bit map. The frequency domain position of the SL CSI-RS is also determined by the transmitting terminal, but the determined frequency domain position of the SL CSI-RS cannot conflict with the PT-RS. FIG. 14 shows a schematic diagram of an SL CSI-RS time-frequency position. In FIG. 14, the number of SL CSI-RS ports is 2, sl-CSI-RS-FirstSymbol is 8, and sl-CSI-RS-FreqAllocation is [b₅, b₄, b₃, b₂, b₁, b₀]=[0,0, 0, 1, 0, 0].

The NR system, introduced in the 3GPP release 15 (R15) standard, is a communication technology used on the existing and new licensed spectrum. The NR system may achieve seamless coverage, high spectrum efficiency, high peak value rate and high reliability of the cellular network. In the LTE system, the unlicensed spectrum (or a license-free spectrum), as a supplementary frequency band for the licensed spectrum used for the cellular network, has been implemented. Similarly, the NR system may also use the unlicensed spectrum as a part of the 5G cellular network technology to provide services to users. In the 3GPP R16 standard, the NR system for the unlicensed spectrum, called NR-unlicensed (NR-U), was discussed.

The NR-U system supports two networking modes: licensed spectrum assisted access and unlicensed spectrum stand-alone access. The former mode requires the use of the licensed spectrum to access the network, and the use of the unlicensed spectrum as a secondary carrier; the latter mode may be stand-alone networking by the unlicensed spectrum, and the UE may directly access the network by the unlicensed spectrum. The range of the unlicensed spectrum used by the NR-U system introduced in the 3GPP R16 is concentrated in the 5 GHz and 6 GHz frequency bands, for example, 5925 to 7125 MHz in the United States or 5925 to 6425 MHz in Europe. In the R16 standard, a band 46 (5150 MHz-5925 MHz) is also newly defined as the unlicensed spectrum for using.

The unlicensed spectrum is a spectrum divided by countries and regions that can be used for radio device communication. This spectrum is generally considered to be a shared spectrum, that is, as long as the communication device meets the regulatory requirements set by countries and regions on the spectrum, it can use the spectrum, without applying for a dedicated spectrum authorization from the dedicated spectrum management agency of the countries and regions. The use of the unlicensed spectrum needs to meet the requirements of regulations specified in various countries and regions, such as the communication device follows the “listen before talk” (LBT) principle when using the unlicensed spectrum. Therefore, the NR technology needs to be enhanced accordingly, to adapt to the regulatory requirements of the unlicensed frequency bands, and efficiently utilize the unlicensed spectrum to provide services. In the 3GPP R16 standard, the standardization of the NR-U technology in the following aspects was mainly completed: the channel sensing process; the initial access process; the control channel design; the HARQ and scheduling; the scheduling-free authorization transmission, etc. This section will introduce these technologies in detail.

Dynamic channel sensing may also be considered as an LBT mode based on LBE (Load Based Equipment). The channel sensing principle of the dynamic channel sensing is that the communication device performs LBT on a carrier of the unlicensed spectrum after a service arrives, and starts to transmit a signal on the carrier after the LBT is successful. The LBT mode of the dynamic channel sensing includes Type 1 channel access mode and Type2 channel access mode. The Type 1 channel access mode is a multi-slot channel detection with random backoff adjusted based on contention window size, where the corresponding channel access priority class (CAPC) p may be selected according to the priority of the service to be transmitted. The Type 2 channel access mode is a channel access mode based on a sensing time slot with a fixed-length, where the Type 2 channel access mode includes Type2A channel access, Type2B channel access and Type2C channel access. Type 1 channel access mode is mainly used by the communication device to initiate channel occupation, and the Type 2 channel access mode is mainly used by the communication device to share channel occupation. A special case that needs to be explained is that, when the base station initiates channel occupation for a transmission of an SS/PBCH block in a discovery reference symbol (DRS) and a DRS window does not include a unicast data transmission of the UE, if the length of the DRS window does not exceed 1 ms and the duty cycle of the DRS window transmission does not exceed 1/20, then the base station may use the Type2A channel access to initiate the channel occupation.

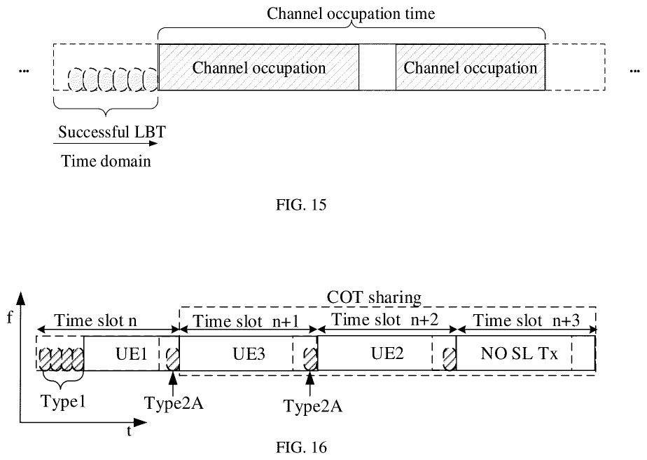

FIG. 15 shows an example of one channel occupation time obtained by a communication device after LBT is successful on a channel of an unlicensed spectrum, and a signal transmission by using a resource within the channel occupation time.

The default channel access mode at the base station side is the Type 1 channel access. Taking the base station as an example, channel access parameters corresponding to the channel access priority class p at the base station side are shown in the following Table 3. If the channel access process ends, the base station may use the channel to transmit the service to be transmitted. The maximum length of time that the base station can use this channel for transmission cannot exceed T_{mcot,p}.

TABLE 3
Channel access parameters corresponding to
different channel access priority classes

| Channel | | | | | |
|---|---|---|---|---|---|
| access priority | | | | | Allowed CWₚ |
| class (p) | mₚ | CW_{min, p} | CW_{max, p} | T_{mcot, p} | values |
| 1 | 2 | 3 | 7 | 2 ms | {3, 7} |
| 2 | 2 | 7 | 15 | 4 ms | {7, 15} |
| 3 | 3 | 15 | 1023 | 6/10 | {15, 31, 63, 127, |
| | | | | ms | 255, 511, 1023} |
| 4 | 7 | 15 | 1023 | 6/10 | {15, 31, 63, 127, |
| | | | | ms | 255, 511, 1023} |

Herein, in the above Table 3, mₚ represents the number of back-off time slots corresponding to the channel access priority class, CWₚ represents the size of the contention window corresponding to the channel access priority class, CW_{min,p} represents the minimum value of the CWₚ value corresponding to the channel access priority class, CW_{max,p} represents the maximum value of the CWₚ value corresponding to the channel access priority class, and T_{mcot,p} represents the maximum length of the channel occupation time corresponding to the channel access priority class.

When the base station initiates the channel occupation time (channel occupy time, COT), in addition to using resources in the COT for a downlink transmission, the base station may share the resources in the COT to the UE for an uplink transmission. When the resources in the COT are shared to the UE for the uplink transmission, the channel access mode that the UE can use is the Type2A channel access, the Type2B channel access or the Type2C channel access, where the Type2A channel access, the Type2B channel access and the Type2C channel access are all the channel access mode based on the monitoring time slot with the fixed-lengths. Type 2 channel access is the channel detection based on the channel monitoring time slot with the fixed-length. The Type 2 channel access may include the following:

Type 2A channel access: the channel detection mode of the terminal device is single-slot channel detection of 25 μs. For example, under Type 2A channel access, the terminal device may perform channel sensing of 25 us before starting a transmission, and transmit data after the channel sensing is successful.

Type 2B channel access: the channel detection mode of the terminal device is single-slot channel detection of 16 μs. For example, under Type 2B channel access, the terminal device may perform channel sensing of 16 us before starting a transmission, and transmit after the channel sensing is successful. Herein, the size of a gap between a starting point position of this transmission and an end position of a last transmission is 16 μs.

Type 2C channel access: the terminal device transmits, without performing channel detection after the gap ends. For example, under Type2C channel access, the terminal device may directly transmit, where the size of a gap between a starting point position of this transmission and an end position of a last transmission is less than or equal to 16 μs. The length of this transmission does not exceed 584 μs.

In SL communication based on the licensed spectrum or the dedicated spectrum, the number of symbols available for the SL transmission in different time slots will not change significantly. The terminal may determine transport block size (TBS) transmitted in a time slot according to the average number of OFDM symbols available in the time slot and the resource bandwidth. The average number of OFDM symbols available in a time slot can be obtained in advance according to the configuration of the resource pool. The receiving terminal may calculate the same TBS according to the resource pool configuration information and the indication information in the SCI, thereby ensuring the correct reception.

When sidelink technology operates on the unlicensed spectrum, it needs to continue to support the existing SL sensing mechanism, to avoid resource conflicts with other SL users; in addition, it also needs to support the channel sensing mechanism of LBT, to avoid resource conflicts with users of other systems (such as WiFi). However, due to the uncertainty of LBT, the UE may succeed in LBT at any position within a time slot. Therefore, the number of OFDM symbols available for the TB transmission in a time slot will also fluctuate greatly. Since a TB may need to be retransmitted, due to LBT, the number of OFDM symbols available for the TB transmission in a retransmission time slot will be different from that of a time slot in which the TB was previously transmitted. As shown in FIG. 16, the terminal may succeed in LBT after the 4-th OFDM symbol of a time slot n, and succeed in LBT before the starting of a time slot n+1 and a time slot n+2. In this case, how to ensure that the TBS remains unchanged in the new transmission process and the retransmitted process, is an urgent problem to be solved.

In the embodiments, a communication method is provided, which includes:
transmitting, by a first terminal device, first information to a second terminal device, where the first information is used to indicate a first reference value in a first time slot, and the first reference value is used by the first terminal device to calculate a reference number of orthogonal frequency division multiplexing (OFDM) symbols when determining transmission block size (TBS).

In some embodiments, the method further includes:
transmitting, by the first terminal device, sidelink information to the second terminal device at a first starting point position, where the first starting point position is one of one or more sidelink transmission starting point positions in the first time slot.

In some embodiments, a starting point position S1 is a first starting point position of the one or more sidelink transmission starting point positions in the first time slot, and the starting point position S1 is determined according to a configuration or pre-configuration of a sidelink (SL) bandwidth part (BWP) in which a resource pool is located, or the starting point position S1 is determined according to a configuration or pre-configuration of a resource pool, and S1 is a positive integer.

In some embodiments, the first time slot further includes a starting point position S2, the starting point position S2 is pre-specified, configured by a network, or pre-configured by a network, and S2 is an integer greater than S1.

In some embodiments, a number N1 of symbols available for a sidelink transmission starting from the starting point position S2 in the first time slot is not less than 6, and N1 is a positive integer.

In some embodiments, the first information is carried in sidelink control information (SCI).

In some embodiments, the first information is carried in a physical sidelink feedback channel (PSFCH) overhead indication field or other fields in the SCI.

In some embodiments, no physical sidelink feedback channel (PSFCH) resource is configured in a resource pool to which the first time slot belongs, and if the first starting point position is a starting point position S1 or S2 in the first time slot, the first reference value is 0 or S2-S1 when determining the TBS, S1 is a positive integer, and S2 is an integer greater than S1.

In some embodiments, a configuration period of a physical sidelink feedback channel (PSFCH) resource in a resource pool to which the first time slot belongs is 1, and if the first starting point position is a starting point position S1 or S2 in the first time slot, the first reference value is 3 or S2−S1+3 when determining the TBS, S1 is a positive integer, and S2 is an integer greater than S1.

In some embodiments, a configuration period of a physical sidelink feedback channel (PSFCH) resource in a resource pool to which the first time slot belongs is greater than 1, and if the first time slot does not include a PSFCH resource, a first starting point position is a starting point position S1 or S2 in the first time slot, or if the first time slot includes a PSFCH resource, a first starting point position is a starting point position S1 in the first time slot. In some embodiments, the first reference value is 0 or 3 when determining the TBS.

In the embodiments, a communication method is provided, which includes:
receiving, by a second terminal device, first information transmitted by a first terminal device, where the first information is used to indicate a first reference value in a first time slot, and the first reference value is used by the first terminal device to calculate a reference number of orthogonal frequency division multiplexing (OFDM) symbols when determining transmission block size (TBS).

In some embodiments, the method further includes:
receiving, by the second terminal device, sidelink information transmitted by the first terminal device at a first starting point position, where the first starting point position is one of one or more sidelink transmission starting point positions in the first time slot.

In some embodiments, a starting point position S1 is a first starting point position of the one or more sidelink transmission starting point positions in the first time slot, and the starting point position S1 is determined according to a configuration or pre-configuration of a sidelink (SL) bandwidth part (BWP) in which a resource pool is located, or the starting point position S1 is determined according to a configuration or pre-configuration of a resource pool, and S1 is a positive integer.

In some embodiments, the first time slot further includes a starting point position S2, the starting point position S2 is pre-specified, configured by a network, or pre-configured by a network, and S2 is an integer greater than S1.

In some embodiments, a number N1 of symbols available for a sidelink transmission starting from the starting point position S2 in the first time slot is not less than 6, and N1 is a positive integer.

In some embodiments, the first information is carried in sidelink control information (SCI).

In some embodiments, the first information is carried in a physical sidelink feedback channel (PSFCH) overhead indication field or other fields in the SCI.

In some embodiments, no physical sidelink feedback channel (PSFCH) resource is configured in a resource pool to which the first time slot belongs, and if the first starting point position is a starting point position S1 or S2 in the first time slot, the first reference value is 0 or S2−S1 when determining the TBS, S1 is a positive integer, and S2 is an integer greater than S1.

In some embodiments, a configuration period of a physical sidelink feedback channel (PSFCH) resource in a resource pool to which the first time slot belongs is 1, and if the first starting point position is a starting point position S1 or S2 in the first time slot, the first reference value is 3 or S2−S1+3 when determining the TBS, S1 is a positive integer, and S2 is an integer greater than S1.

In some embodiments, a configuration period of a physical sidelink feedback channel (PSFCH) resource in a resource pool to which the first time slot belongs is greater than 1, and if the first time slot does not include a PSFCH resource, a first starting point position is a starting point position S1 or S2 in the first time slot, or if the first time slot includes a PSFCH resource, a first starting point position is a starting point position S1 in the first time slot.

In some embodiments, the first reference value is 0 or 3 when determining the TBS.

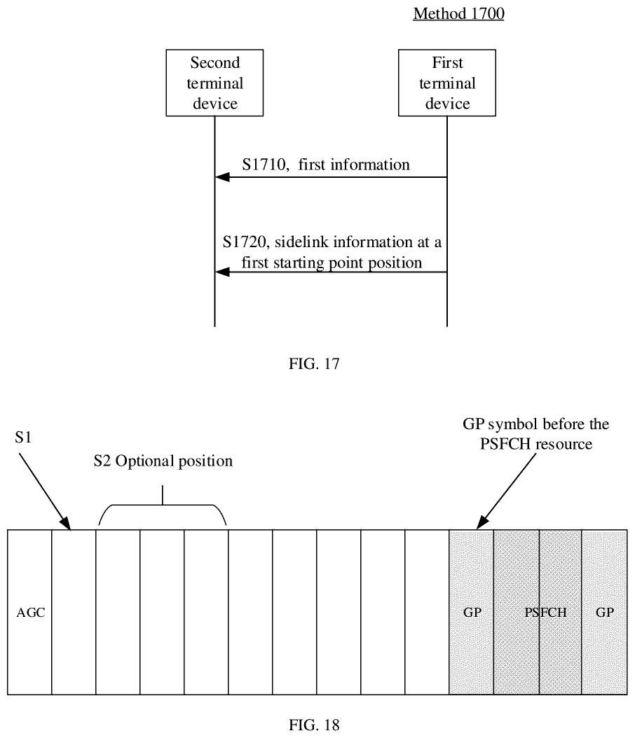

In order to solve one or more of the above technical problems, the present disclosure proposes a communication method and a communication apparatus, which can ensure that the TBSs determined by the transmitter and the receiver in the transmission process of the same TB are the same, thereby ensuring the correct reception of data. The embodiments of the present disclosure are described in detail exemplarily below with reference to FIG. 17 to FIG. 20.

FIG. 17 is a schematic flowchart of a communication method according to the embodiments of the present disclosure. The method 1700 shown in FIG. 17 may include steps S1710 and S1720, which are as follows:

S1710, a first terminal device transmits first information to a second terminal device.

The first terminal device may transmit the first information to the second terminal device in an unlicensed frequency band.

The first information may be used to indicate a first reference value in a first time slot. The first reference value may be used to calculate the reference number of OFDM symbols in the first time slot. For example, the first reference value may be used by the first terminal device to calculate a reference number of OFDM symbols when determining TBS; or, the first reference value may also be used by the second terminal device to calculate a reference number of OFDM symbols when determining TBS. Optionally, the first reference value may be determined by the first terminal device, pre-specified by a protocol, configured by a network, or pre-configured by a network.

It should be noted that the reference number of OFDM symbols mentioned here may not be the actual number of OFDM symbols in the first time slot, but it is a reference value set to ensure that the TBS determined in the PSSCH retransmission process (determined by the transmitter and the receiver) remains unchanged.

The above-mentioned TBS may refer to the TB size of sidelink data transmitted by the first terminal device to the second terminal device. That is to say, the first reference value may be used by the first terminal device to calculate the reference number of OFDM symbols when transmitting the sidelink data, and may also be used by the second terminal device to calculate the reference number of OFDM symbols when receiving the sidelink data.

In some embodiments, the first information may be carried in sidelink control information (SCI). For example, the first information may be carried in a PSFCH overhead indication field in the SCI; or, the first information may also be carried in other fields in the SCI, which is not limited to the present disclosure.

In the embodiments of the present disclosure, a first terminal device transmits first information to a second terminal device, where the first information is used to indicate a first reference value in a first time slot, and the first reference value is used by the first terminal device to calculate a reference number of orthogonal frequency division multiplexing (OFDM) symbols when determining transmission block size (TBS), which may ensure that the TBSs determined by the transmitter and the receiver in the transmission process of the same TB are the same, thereby ensuring the correct reception of data.

In some embodiments, the method 1700 may further include a step S1720, which is as follows:

S1720: the first terminal device transmits sidelink information to the second terminal device at a first starting point position.

The first terminal device may transmit the sidelink information to the second terminal device at the first starting point position on an unlicensed frequency band.

The first starting point position is one of one or more sidelink transmission starting point positions in the first time slot.

In some embodiments, a starting point position S1 may be a first starting point position of the one or more sidelink transmission starting point positions in the first time slot. Optionally, the starting point position S1 may be determined according to a configuration or pre-configuration of a sidelink (SL) bandwidth part (BWP) in which a resource pool is located, or the starting point position S1 may also be determined according to a configuration or pre-configuration of a resource pool. Herein, S1 is a positive integer.

The first time slot may also include a starting point position S2. Optionally, the starting point position S2 may be pre-specified (e.g., specified by a protocol), configured by a network, or pre-configured by a network. Herein, S2 is an integer greater than S1. Optionally, a number N1 of OFDM symbols available for a sidelink transmission starting from the starting point position S2 in the first time slot is not less than 6, and N1 is a positive integer.

In some embodiments, no PSFCH resource may be configured in the resource pool to which the first time slot belongs. At this time, if the first starting point position is a starting point position S1 or S2 in the first time slot, the first reference value may be 0 or S2-S1 when the first terminal device determines the TBS. Accordingly, the second terminal device may determine the first reference value according to the indication of the first information, and determine the TBS by using the same reference number of OFDM symbols as the first terminal device. Therefore, it can be ensured that the TBSs determined by the transmitter and the receiver in the transmission process of the same TB are the same, thereby ensuring the correct reception of data.

In some embodiments, a configuration period of a PSFCH resource in a resource pool to which the first time slot belongs is 1, that is, each time slot contains PSFCH resources. At this time, if the first starting point position is a starting point position S1 or S2 in the first time slot, the first reference value may be 3 or S2−S1+3 when the first terminal device determines the TBS. Accordingly, the second terminal device may determine the first reference value according to the indication of the first information, and determine the TBS by using the same reference number of OFDM symbols as the first terminal device.

In some embodiments, a configuration period of a PSFCH resource in a resource pool to which the first time slot belongs is greater than 1, that is, only a part of time slots contain PSFCH resources. At this time, if the first time slot does not include a PSFCH resource, a first starting point position may be a starting point position S1 or S2 in the first time slot, or if the first time slot includes a PSFCH resource, a first starting point position may be a starting point position S1 in the first time slot. Optionally, the first reference value may be 0 or 3 when the first terminal device determines the TBS. Accordingly, the second terminal device may determine the first reference value according to the indication of the first information, and determine the TBS by using the same reference number of OFDM symbols as the first terminal device.

The following describes several implementations of schemes of the present disclosure in detail, according to whether a PSFCH resource is configured in the resource pool. For ease of understanding, the following embodiments are described by taking an example in which a time slot contains at most two starting point positions, and the present disclosure does not limit the number of starting point positions contained in a time slot.

Mode 1: no PSFCH resource is configured in the resource pool, and the terminal device may perform a sidelink transmission starting from a plurality of starting point positions in a time slot.

If no PSFCH resource is configured in the resource pool, that is, the period of the PSFCH resource is configured to 0, then all time slots may not contain a PSFCH resource. At this time, the terminal device may perform a sidelink transmission starting from two starting point positions in the time slot.

Herein, the first starting point position S1 may be determined by the terminal device according to a configuration or pre-configuration of an SL BWP in which the resource pool is located, or may also be determined by the terminal device according to a configuration or pre-configuration of the resource pool. The second starting point position S2 may be defined by a communication protocol, configured or pre-configured by a network. For example, the value of S2 may be defined by a standard as S1+3, or the value of S2 may also be configured or pre-configured by the network as other values.

Optionally, it may be ensured that the number of OFDM symbols available for the sidelink transmission starting from S2 (including S2) is not less than 6. In this way, large fluctuations in the code rate when the same TB is transmitted on different time slots can be avoided, thereby enabling to improve the stability and reliability of the sidelink transmission.

If the terminal device determines, according to the configuration or pre-configuration of the resource pool, that the sidelink transmission is allowed to start at the plurality of starting points in the resource pool, there is a specific field for indicating the starting point positions, in the PSCCH transmitted in the resource pool. For example, the “PSFCH overhead indication” field in the SCI format 1-A may be reused, or a new field may be introduced, and the value of the field may be 1 bit. For ease of description, in the following embodiments, it is assumed that this field set to 0 represents S1, and this field set to 1 represents S2. When the terminal N_{RE}′ may be calculated according to formula (2). At this time, what is determines TBS, different from the prior art is, N_{symb}^{PSFCH}=0 or S2-S1. Herein, N_{symb}^{PSFCH} may be indicated by the “PSFCH symbol number” field in the SCI, which may represent the reference value of the number of PSFCH symbols.

For the transmitting terminal (i.e., the first terminal device), if it sets N_{symb}^{PSFCH} to S2-S1 when calculating TBS, or transmits an initial transmission of a TB starting from S2, the transmitting terminal may set the starting point position indication field to 1 when transmitting the PSCCH that schedules the new transmission and retransmission of the TB; if it sets N_{symb}^{PSFCH} to 0 when calculating TBS, or transmits an initial transmission of a TB starting from S1, the transmitting terminal may set the value of the starting point position indication field to 0 when transmitting the PSCCH that schedules the new transmission and retransmission of the symb TB. When the transmitting terminal calculates the TBS according to N_{symb}^{PSFCH}=0, or sets the starting point position indication field to 0, the transmitting terminal cannot transmit the new transmission and/or retransmission of the TB starting from other starting points other than S1.

For the receiving terminal (i.e., the second terminal device), if the value of the starting symb point position indication field in the received PSCCH is 0, it may set N_{symb}^{PSFCH} to 0 when calculating the TBS of the TB scheduled by the PSCCH; otherwise, it may set to N_{symb}^{PSFCH} S2−S1.

Mode 2: when a PSFCH resource is configured in the resource pool and a configuration period of the PSFCH is 1, the terminal device may perform a sidelink transmission starting from a plurality of starting point positions in a time slot.

In this embodiment, if the configuration or pre-configuration information of the resource pool indicates that the sidelink transmission is allowed to start at the plurality of starting points in the resource pool, the terminal device may perform the sidelink transmission starting from two starting point positions in a time slot.

Herein, the first starting point position S1 may be determined by the terminal device according to the configuration or pre-configuration of the SL BWP in which the resource pool is located, or may also be determined by the terminal device according to the configuration or pre-configuration of the resource pool. The second starting point position S2 may be defined by a standard, configured or preconfigured by a network. For example, the value of S2 may be configured or preconfigured by the network to other values.

Optionally, it may be ensured that the number of OFDM symbols available for the sidelink transmission starting from S2 (including S2) to the GP symbol before the PSFCH symbol is not less than 6, as shown in FIG. 18. In this way, large fluctuations in the code rate when the same TB is transmitted on different time slots may be avoided, thereby enabling to improve the stability and reliability of the sidelink transmission.

If the terminal determines, according to the configuration or pre-configuration of the resource pool, that the sidelink transmission is allowed to start at a plurality of starting points in the resource pool, there is a specific field for indicating the starting point positions, in the PSCCH transmitted in the resource pool. For example, the “PSFCH overhead indication” field in the SCI format 1-A may be reused, or a new field may be introduced, and the value of the field may be 1 bit. For ease of description, in the following embodiments, it is assumed that this field set to 0 represents S1, and this field set to 1 represents S2. When the terminal determines TBS, N_{RE}′ may be calculated according to formula (2). The difference from the previous one is, N_{symb}^{PSFCH}=3 or S2−S1+3.

For the transmitting terminal, if it sets N_{symb}^{PSFCH} to S2−S1+3 when calculating TBS, or transmits an initial transmission of a TB starting from S2, the transmitting terminal should set the transmission starting point position indication field to 1 when transmitting the PSCCH that schedules the new transmission and retransmission of the TB; if it sets N_{symb}^{PSFCH} to 3 when calculating TBS, or transmits an initial transmission of a TB starting from S1, the transmitting terminal may set the transmission starting point position indication field to 0 when transmitting the PSCCH that schedules the new transmission and retransmission of the TB. When the transmitting terminal calculates the TBS according to N_{symb}^{PSFCH}=3, or sets the starting point position indication field to 0, the transmitting terminal cannot transmit the new transmission and/or retransmission of the TB starting from other starting points other than S1.

For the receiving terminal, if the value of the starting point position indication field in the received PSCCH is 0, it may set symb N_{symb}^{PSFCH} to 3 when calculating the TBS of the TB scheduled by the PSCCH; otherwise, it may set N_{symb}^{PSFCH} to S2−S1+3.

Mode 3: when a PSFCH resource is configured in the resource pool and a period of the PSFCH resource is 2 or 4, on a time slot without the PSFCH resource, the terminal device may perform the sidelink transmission starting from a plurality of starting point positions in the time slot; on a time slot with the PSFCH resource, the terminal device can perform the sidelink transmission starting from only one starting point position.

In this embodiment, in the resource pool, there are PSFCH resources in a part of time slots, and there is no PSFCH resource in other time slots. In a time slot without the PSFCH resource, the terminal device may perform the sidelink transmission starting from two starting point positions in a time slot. Herein, the first position S1 may be determined by the terminal device according to the configuration or pre-configuration of the SL BWP in which the resource pool is located, or may also be determined by the terminal device according to the configuration or pre-configuration of the resource pool. The second position S2 may be defined by a standard, configured or pre-configured by a network. For example, the value of S2 may be defined by the standard as S1+3, or the value of S2 may also be configured or pre-configured by the network as other values.

Optionally, it may be ensured that the number of OFDM symbols available for the sidelink transmission starting from S2 (including S2) is not less than 6. In this way, large fluctuations in the code rate when the same TB is transmitted on different time slots can be avoided, thereby enabling to improve the stability and reliability of the sidelink transmission.

When the terminal determines TBS, N_{RE}′ is calculated according to formula (2), except that, N_{symb}^{PSFCH}=0 or 3.

For the transmitting terminal, if it sets N_{symb}^{PSFCH} to 3 when calculating TBS, the N PSFCH “PSFCH overhead indication” field should be set to 1 when transmitting the PSCCH that schedules the TB; if it sets N_{symb}^{PSFCH} to 0 when calculating TBS, the value of the “PSFCH overhead indication” field may be set to 0 when transmitting the PSCCH that schedules the TB.

For the receiving terminal, if the value of the “PSFCH overhead indication” field in symb the received PSCCH is 0, the receiving terminal may set N_{symb}^{PSFCH} to 0 when calculating the TBS of the TB scheduled by the PSCCH; otherwise, the receiving terminal should set N_{symb}^{PSFCH} symb to 3.

Mode 4: when a PSFCH resource is configured in the resource pool and a period of the PSFCH resource is 2 or 4, the terminal device may perform the sidelink transmission starting from a plurality of starting point positions on each time slot, but the second starting point positions on a time slot with the PSFCH resource and on a time slot without the PSFCH resource are different.

In this embodiment, in the resource pool, there are PSFCH resources in a part of time slots, and there is no PSFCH resource in other time slots.

In a time slot without the PSFCH resource, the terminal may perform the sidelink transmission starting from two positions in a time slot. The first starting point position S1 may be determined by the terminal device according to the configuration or pre-configuration of the SL BWP in which the resource pool is located, or may also be determined by the terminal device according to the configuration or pre-configuration of the resource pool. The second position S2 may be defined by a standard, configured or pre-configured by a network. For example, the value of S2 may be defined by the standard, or configured or pre-configured by the network to be other values.

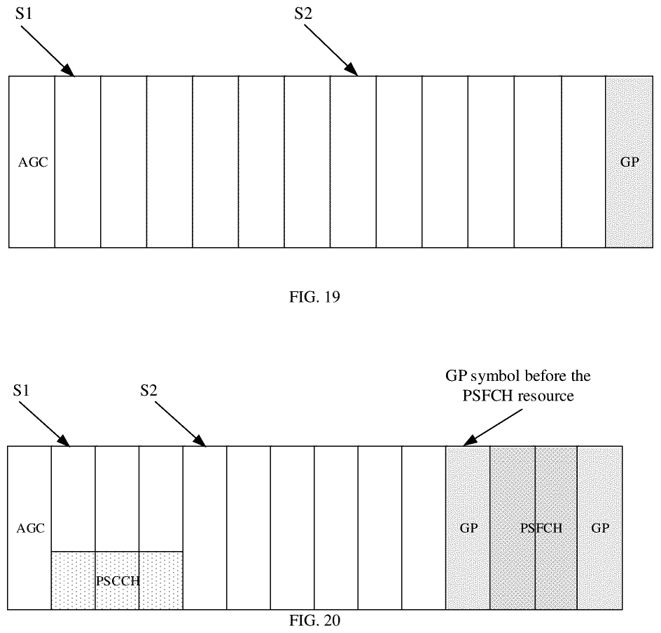

Optionally, it may be ensured that the number N1 of OFDM symbols available for the sidelink transmission starting from S2 (including S2) is not less than 6, for example, as shown in FIG. 19.

In a time slot with the PSFCH resource, the terminal device may perform the sidelink transmission starting from two starting point positions in a time slot. Herein, the first starting point position S1 may be determined by the terminal device according to the configuration or pre-configuration of the SL BWP in which the resource pool is located, or may also be determined by the terminal device according to the configuration or pre-configuration of the resource pool. The second position S2 may be defined by a standard, configured or pre-configured by a network. For example, the value of S2 may be defined by the standard, or configured or pre-configured by the network to be other values.

Optionally, it may be ensured that the number N2 of OFDM symbols available for the sidelink transmission starting from S2 (including S2) to the GP symbol before the PSFCH symbol is not less than 6, for example, as shown in FIG. 20. In this way, large fluctuations in the code rate when the same TB is transmitted on different time slots may be avoided, thereby enabling to improve the stability and reliability of the sidelink transmission.

It may be ensured that N1=N2. In this way, large fluctuations in the code rate when the same TB is transmitted on different time slots may be avoided.

When the terminal device determines TBS, N_{RE}′ may be calculated according to formula (2). What is different from the prior art is, symb N_{symb}^{PSFCH}=0 or S2−S1.

For the transmitting terminal, if it sets N_{symb}^{PSFCH} to N1 when calculating TBS, the symb transmitting terminal may set the “PSFCH overhead indication” field to 1 when transmitting the PSCCH that schedules the TB; if it sets N_{symb}^{PSFCH} to 0 when calculating TBS, the symb transmitting terminal may set the value of the “PSFCH overhead indication” field to 0 when transmitting the PSCCH that schedules the TB.

For the receiving terminal, if the value of the “PSFCH overhead indication” field in the received PSCCH is 0, the receiving terminal may set N_{symb}^{PSFCH} to 0 when calculating the TBS of the TB scheduled by the PSCCH; otherwise, the receiving terminal may set symb NPSFCH to S2−S1.

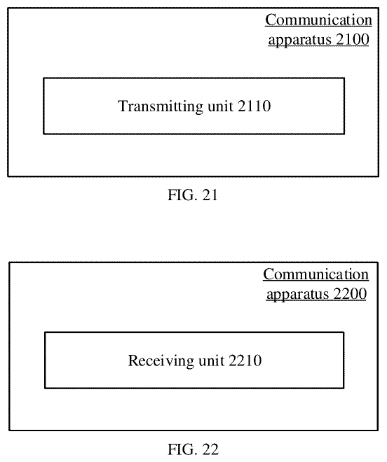

The above describes the method embodiments of the present disclosure in detail in combination with FIG. 1 to FIG. 20, and the following describes apparatus embodiments of the present disclosure in detail in combination with FIG. 21 to FIG. 23. It should be understood that the description of the method embodiments corresponds to the description of the device embodiments, and therefore, for parts that are not described in detail, reference may be made to the previous method embodiments.

FIG. 21 is a schematic structural diagram of a communication apparatus provided by an embodiment of the present disclosure. As shown in FIG. 21, the apparatus 2100 includes a transmitting unit 2110, which is as follows:
the transmitting unit 2110, configured to transmit first information to a second terminal device, where the first information is used to indicate a first reference value in a first time slot, and the first reference value is used by the first terminal device to calculate a reference number of orthogonal frequency division multiplexing (OFDM) symbols when determining transmission block size (TBS).

Optionally, the transmitting unit 2110 is further configured to: transmit sidelink information to the second terminal device at a first starting point position, where the first starting point position is one of one or more sidelink transmission starting point positions in the first time slot.

Optionally, a starting point position S1 is a first starting point position of the one or more sidelink transmission starting point positions in the first time slot, and the starting point position S1 is determined according to a configuration or pre-configuration of a sidelink (SL) bandwidth part (BWP) in which a resource pool is located, or the starting point position S1 is determined according to a configuration or pre-configuration of a resource pool, and S1 is a positive integer.

Optionally, the first time slot further includes a starting point position S2, the starting point position S2 is pre-specified, configured by a network, or pre-configured by a network, and S2 is an integer greater than S1.

Optionally, a number N1 of symbols available for a sidelink transmission starting from the starting point position S2 in the first time slot is not less than 6, and N1 is a positive integer.

Optionally, the first information is carried in sidelink control information (SCI).

Optionally, the first information is carried in a physical sidelink feedback channel (PSFCH) overhead indication field or other fields in the SCI.

Optionally, no physical sidelink feedback channel (PSFCH) resource is configured in a resource pool to which the first time slot belongs, and if the first starting point position is a starting point position S1 or S2 in the first time slot, the first reference value is 0 or S2−S1 when determining the TBS, S1 is a positive integer, and S2 is an integer greater than S1.

Optionally, a configuration period of a physical sidelink feedback channel (PSFCH) resource in a resource pool to which the first time slot belongs is 1, and if the first starting point position is a starting point position S1 or S2 in the first time slot, the first reference value is 3 or S2−S1+3 when determining the TBS, S1 is a positive integer, and S2 is an integer greater than S1.

Optionally, a configuration period of a physical sidelink feedback channel (PSFCH) resource in a resource pool to which the first time slot belongs is greater than 1, and if the first time slot does not include a PSFCH resource, a first starting point position is a starting point position S1 or S2 in the first time slot, or if the first time slot includes a PSFCH resource, a first starting point position is a starting point position S1 in the first time slot.

Optionally, the first reference value is 0 or 3 when determining the TBS.

FIG. 22 is a schematic structural diagram of a communication apparatus provided by an embodiment of the present disclosure. The communication apparatus 2200 in FIG. 22 includes a receiving unit 2210, which is as follows:
the receiving unit 2210, configured to receive first information transmitted by a first terminal device, where the first information is used to indicate a first reference value in a first time slot, and the first reference value is used by the first terminal device to calculate a reference number of orthogonal frequency division multiplexing (OFDM) symbols when determining transmission block size (TBS).

Optionally, the receiving unit 2210 is further configured to: receive sidelink information transmitted by the first terminal device at a first starting point position, where the first starting point position is one of one or more sidelink transmission starting point positions in the first time slot.

Optionally, a starting point position S1 is a first starting point position of the one or more sidelink transmission starting point positions in the first time slot, and the starting point position S1 is determined according to a configuration or pre-configuration of a sidelink (SL) bandwidth part (BWP) in which a resource pool is located, or the starting point position S1 is determined according to a configuration or pre-configuration of a resource pool, and S1 is a positive integer.

Optionally, the first time slot further includes a starting point position S2, the starting point position S2 is pre-specified, configured by a network, or pre-configured by a network, and S2 is an integer greater than S1.

Optionally, a number N1 of symbols available for a sidelink transmission starting from the starting point position S2 in the first time slot is not less than 6, and N1 is a positive integer.

Optionally, the first information is carried in sidelink control information (SCI).

Optionally, the first information is carried in a physical sidelink feedback channel (PSFCH) overhead indication field or other fields in the SCI.

Optionally, no physical sidelink feedback channel (PSFCH) resource is configured in a resource pool to which the first time slot belongs, and if the first starting point position is a starting point position S1 or S2 in the first time slot, the first reference value is 0 or S2−S1 when determining the TBS, S1 is a positive integer, and S2 is an integer greater than S1.

Optionally, a configuration period of a physical sidelink feedback channel (PSFCH) resource in a resource pool to which the first time slot belongs is 1, and if the first starting point position is a starting point position S1 or S2 in the first time slot, the first reference value is 3 or S2−S1+3 when determining the TBS, S1 is a positive integer, and S2 is an integer greater than S1.

Optionally, a configuration period of a physical sidelink feedback channel (PSFCH) resource in a resource pool to which the first time slot belongs is greater than 1, and if the first time slot does not include a PSFCH resource, a first starting point position is a starting point position S1 or S2 in the first time slot, or if the first time slot includes a PSFCH resource, a first starting point position is a starting point position S1 in the first time slot.

Optionally, the first reference value is 0 or 3 when determining the TBS.

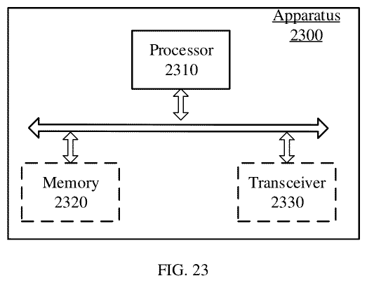

FIG. 23 is a schematic structural diagram of an apparatus provided by an embodiment of the present disclosure. Dashed lines in FIG. 23 indicate that the unit or module is optional. The apparatus 2300 may be configured to implement the method described in the above method embodiments. The apparatus 2300 may be a chip or a communication apparatus.

The apparatus 2300 may include one or more processors 2310. The processor 2310 may support the apparatus 2300 to implement the method described in the above method embodiments. The processor 2310 may be a general processor or a dedicated processor. For example, the processor may be a central processing unit (CPU). Or, the processor may also be other general processors, digital signal processor (DSP), application specific integrated circuit (ASIC), field programmable gate array (FPGA), or other programmable logic devices, discrete gate or transistor logic devices, discrete hardware components, etc. The general processor may be a microprocessor, or the processor may be any conventional processor or the like.

The apparatus 2300 may also include one or more memories 2320. The memory 2320 stores a program, which may be performed by the processor 2310, so that the processor 2310 performs the method described in the above method embodiments. The memory 2320 may be independent of the processor 2310 or may be integrated into the processor 2310.

The apparatus 2300 may further include a transceiver 2330. The processor 2310 may communicate with other devices or chips via the transceiver 2330. For example, the processor 2310 may transmit and receive data with other devices or chips via the transceiver 2330.

The embodiments of the present disclosure also provide a non-transitory computer-readable storage medium configured to store a program. The non-transitory computer-readable storage medium may be applied to the communication apparatus provided by the embodiments of the present disclosure, and the program causes a computer to perform the method performed by the communication apparatus in various embodiments of the present disclosure.

The embodiments of the present disclosure also provide a computer program product. The computer program product includes a program. The computer program product may be applied to the communication apparatus provided by the embodiments of the present disclosure, and the program causes a computer to perform the method performed by the communication apparatus in various embodiments of the present disclosure.

The embodiments of the present disclosure also provide a computer program. The computer program may be applied to the communication apparatus provided by the embodiments of the present disclosure, and the computer program causes a computer to perform the method performed by the communication apparatus in various embodiments of the present disclosure.

It should be understood that in the embodiments of the present disclosure, “B corresponding to A” means that B is associated with A, and B may be determined according to A. However, it should also be understood that determining B according to A does not mean determining B based on only A, and B may also be determined according to A and/or other information.

It should be understood that the term herein “and/or” is only an association relationship for describing associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that in the various embodiments of the present disclosure, the size of the sequence numbers of the above processes does not mean the order of execution. The order of execution of each process should be determined by its function and internal logic, but should not constitute any limitation on the implementation processes of the embodiments of the present disclosure.

In several embodiments provided by present disclosure, it should be understood that the disclosed system, apparatus and method may be implemented in other ways. For example, the apparatus embodiments described above are merely illustrative. For example, the division of the units is merely a division of logical functions. There may be other division methods in actual implementations. For example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

The above embodiments may be implemented in whole or in part by software, hardware, firmware or any combination thereof. When the embodiments are implemented by using software, they may be implemented in whole or in part in the form of a computer program product. The computer program product includes one or more computer instructions. When the computer program instructions are loaded and executed on a computer, the processes or functions described in accordance with the embodiments of the present disclosure are generated in whole or in part. The computer may be a general computer, a dedicated computer, a computer network, or another programmable apparatus. The computer instructions may be stored in a non-transitory computer-readable storage medium, or transmitted from one non-transitory computer-readable storage medium to another non-transitory computer-readable storage medium. For example, the computer instructions may be transmitted from one website, computer, server, or data center to another website, computer, server, or data center in a wired (e.g., coaxial cable, optical fiber, digital subscriber line (DSL)) or wireless (e.g., infrared, wireless, microwave, etc.) manner. The non-transitory computer-readable storage medium may be any available medium that can be read by a computer, or may be a data storage device such as a server or a data center that includes one or more available media, etc. The available medium may be a magnetic medium (e.g., a floppy disk, a hard disk, a magnetic tape), an optical medium (e.g., a digital video disc (DVD)), or a semiconductor medium (e.g., a solid state disk (SSD)), etc.

The above content is only implementations of the present disclosure, but the protection scope of the present disclosure is not limited thereto, and any skilled familiar with this technical field may easily think of changes or substitutions within the technical scope disclosed in the present disclosure, which should be all covered within the protection scope of the present disclosure. Therefore, the protection scope of the present disclosure should be subject to the protection scope of the claims.

What is claimed is:

1. A communication method, comprising:
transmitting, by a first terminal device, first information to a second terminal device, wherein the first information is used to indicate a first reference value in a first time slot, and the first reference value is used by the first terminal device to calculate a reference number of orthogonal frequency division multiplexing (OFDM) symbols when determining transmission block size (TBS).

2. The method according to claim 1, wherein the method further comprises:
transmitting, by the first terminal device, sidelink information to the second terminal device at a first starting point position, wherein the first starting point position is one of one or more sidelink transmission starting point positions in the first time slot.

3. The method according to claim 2, wherein a starting point position S1 is a first starting point position of the one or more sidelink transmission starting point positions in the first time slot, and the starting point position S1 is determined according to a configuration or pre-configuration of a sidelink (SL) bandwidth part (BWP) in which a resource pool is located, or the starting point position S1 is determined according to a configuration or pre-configuration of a resource pool, and S1 is a positive integer.

4. The method according to claim 3, wherein the first time slot further comprises a starting point position S2, the starting point position S2 is pre-specified, configured by a network, or pre-configured by a network, and S2 is an integer greater than S1; wherein
a number N1 of symbols available for a sidelink transmission starting from the starting point position S2 in the first time slot is not less than 6, and N1 is a positive integer.

5. The method according to claim 1, wherein the first information is carried in sidelink control information (SCI).

6. The method according to claim 5, wherein the first information is carried in a physical sidelink feedback channel (PSFCH) overhead indication field or other fields in the SCI.

7. The method according to claim 2, wherein a configuration period of a physical sidelink feedback channel (PSFCH) resource in a resource pool to which the first time slot belongs is greater than 1, and if the first time slot does not comprise a PSFCH resource, a first starting point position is a starting point position S1 or S2 in the first time slot, or if the first time slot comprises a PSFCH resource, a first starting point position is a starting point position S1 in the first time slot.

8. The method according to claim 7, wherein the first reference value is 0 or 3 when determining the TBS.

9. A communication method, comprising:
receiving, by a second terminal device, first information transmitted by a first terminal device, wherein the first information is used to indicate a first reference value in a first time slot, and the first reference value is used by the first terminal device to calculate a reference number of orthogonal frequency division multiplexing (OFDM) symbols when determining transmission block size (TBS).

10. The method according to claim 9, wherein the method further comprises:
receiving, by the second terminal device, sidelink information transmitted by the first terminal device at a first starting point position, wherein the first starting point position is one of one or more sidelink transmission starting point positions in the first time slot.

11. The method according to claim 10, wherein a starting point position S1 is a first starting point position of the one or more sidelink transmission starting point positions in the first time slot, and the starting point position S1 is determined according to a configuration or pre-configuration of a sidelink (SL) bandwidth part (BWP) in which a resource pool is located, or the starting point position S1 is determined according to a configuration or pre-configuration of a resource pool, and S1 is a positive integer.

12. The method according to claim 11, wherein the first time slot further comprises a starting point position S2, the starting point position S2 is pre-specified, configured by a network, or pre-configured by a network, and S2 is an integer greater than S1; wherein
a number N1 of symbols available for a sidelink transmission starting from the starting point position S2 in the first time slot is not less than 6, and N1 is a positive integer.

13. The method according to claim 9, wherein the first information is carried in sidelink control information (SCI).

14. The method according to claim 13, wherein the first information is carried in a physical sidelink feedback channel (PSFCH) overhead indication field or other fields in the SCI.

15. The method according to claim 10, wherein a configuration period of a physical sidelink feedback channel (PSFCH) resource in a resource pool to which the first time slot belongs is greater than 1, and if the first time slot does not comprise a PSFCH resource, a first starting point position is a starting point position S1 or S2 in the first time slot, or if the first time slot comprises a PSFCH resource, a first starting point position is a starting point position S1 in the first time slot.

16. The method according to claim 15, wherein the first reference value is 0 or 3 when determining the TBS.

17. A communication apparatus, wherein the communication apparatus is a first terminal device, the first terminal device comprises a memory, a transceiver and a processor, wherein the memory is configured to store a program, the transceiver is configured to transmit and receive data, and the processor is configured to call the program in the memory, to cause the first terminal device to perform:
transmitting first information to a second terminal device, wherein the first information is used to indicate a first reference value in a first time slot, and the first reference value is used by the first terminal device to calculate a reference number of orthogonal frequency division multiplexing (OFDM) symbols when determining transmission block size (TBS).

18. The communication apparatus according to claim 17, wherein the first terminal device further performs:
transmitting sidelink information to the second terminal device at a first starting point position, wherein the first starting point position is one of one or more sidelink transmission starting point positions in the first time slot.

19. The communication apparatus according to claim 17, wherein the first information is carried in sidelink control information (SCI); wherein
the first information is carried in a physical sidelink feedback channel (PSFCH) overhead indication field or other fields in the SCI.

20. A communication apparatus, wherein the communication apparatus is a second terminal device, the second terminal device comprises a memory, a transceiver and a processor, wherein the memory is configured to store a program, the transceiver is configured to transmit and receive data, and the processor is configured to call the program in the memory, to perform the method according to claim 9.
